(19) United States
(12) Patent Application Publication
(10) Pub. No.: US 2019/0369938 A1
(43) Pub. Date: Dec. 5, 2019

(54) INFORMATION PROCESSING METHOD AND RELATED ELECTRONIC DEVICE

(71) Applicant: Lenovo (Beijing) Co., Ltd., Beijing (CN)

(72) Inventors: Xin JIANG, Beijing (CN); Meng WU, Beijing (CN)

(21) Appl. No.: 16/429,654

(22) Filed: Jun. 3, 2019

(30) Foreign Application Priority Data
Jun. 1, 2018 (CN) 201810558060.3

(51) Int. Cl. G06F 3/14; G06F 3/0481; G06F 3/0484; G06F 21/62

(52) U.S. Cl. CPC G06F 3/1423; G06F 3/0481; G06F 3/0482; G06F 21/6245; G06F 3/04817; G06F 3/0484

(57) ABSTRACT

An information processing method includes receiving a first operation instruction for a target object, determining a target screen based on the first operation instruction and the first screen displaying the target object, and displaying content information corresponding to the target object in the target screen. The target object is displayed on a first screen of an electronic device. The electronic device includes the first screen and one or more second screens.

### CROSS-REFERENCE TO RELATED APPLICATION

This application claims the priority of China Application No. 201810558060.3, filed on Jun. 1, 2018, the entire content of which is incorporated herein by reference.

### TECHNICAL FIELD

The present disclosure relates to the information processing technology and, in particular, to an information processing method and an electronic device.

### BACKGROUND

Augmented Reality (AR) is a technology that “seamlessly” integrates information of a real world and information of a virtual world. Some entity information, including, e.g., visual information, sound, taste, touch, etc., is difficult to be experienced in a certain time and/or in a certain space in the real world. AR can simulate and superimpose such entity information to generate virtual information through computer science and other sciences and technologies, and apply the virtual information to the real world to allow users to perceive by human senses, thereby achieving a sensory experience beyond reality.

Using visual AR, only users wearing AR devices can see contents on a virtual display, which can protect users' privacy. Contents on the physical display are visible to everyone, which is not private.

However, in existing technologies, when a program or a file is started or opened, the system will display a window of the program or the file on the physical display by default, rather than displaying the window on a designated screen, and the privacy of the AR device thus cannot be well protected.

### SUMMARY

In accordance with the disclosure, one aspect of the present disclosure provides an information processing method, the method includes receiving a first operation instruction for a target object, determining a target screen based on the first operation instruction and the first screen displaying the target object, and displaying content information corresponding to the target object in the target screen. The target object is displayed on a first screen of an electronic device. The electronic device includes the first screen and one or more second screens.

Also in accordance with the disclosure, another aspect of the present disclosure provides an electronic device including a first screen configured to display a target object, one or more second screens, and a processor. The processor is configured to receive a first operation instruction for the target object, determine a target screen based on the first operation instruction and the first screen displaying the target object, and display content information corresponding to the target object in a target screen.

Also in accordance with the disclosure, another aspect of the present disclosure provides an electronic device including a processor and a memory configured to store computer programs. When the computer programs are executed by the processor, the processor can be configured to receive a first operation instruction for the target object, determine a target screen based on the first operation instruction and the first screen displaying the target object, and display content information corresponding to the target object in a target screen.

The present disclosure provides the information processing method and the electronic device. The electronic device can implement the information processing method. The electronic device can receive the first operation instruction for the target object. The target object is displayed on the first screen of the electronic device. The electronic device includes the at least one second screen, which is different from the first screen. The electronic device can also display the content information corresponding to the target object on the target screen. The target screen can be determined based on the first operation instruction and/or the first screen displaying the target object. As such, the target object can be displayed on the screen where the target object is located without performing screen setting through a home screen to select the screen for displaying the target object, thereby effectively improving the operation convenience for the target object.

### DESCRIPTION OF THE DRAWINGS

FIG. 1 is a schematic flowchart of an information processing method according to some embodiments of the present disclosure.

FIG. 2 is a schematic diagram of an exemplary implementation of an information processing method according to some embodiments of the present disclosure.

FIG. 3 is a second schematic diagram of another exemplary implementation of an information processing method according to some embodiments of the present disclosure.

FIG. 4 is a schematic structural diagram of an electronic device according to some embodiments of the present disclosure.

FIG. 5 is a schematic structural diagram of an electronic device according to some other embodiments of the present disclosure.

### DETAILED DESCRIPTION

The features and technical solutions of present disclosure are described in detail with reference to the accompanying drawings in the accompanying drawings. The accompany drawings are for illustrative purposes and are not intended to limit the present disclosure.

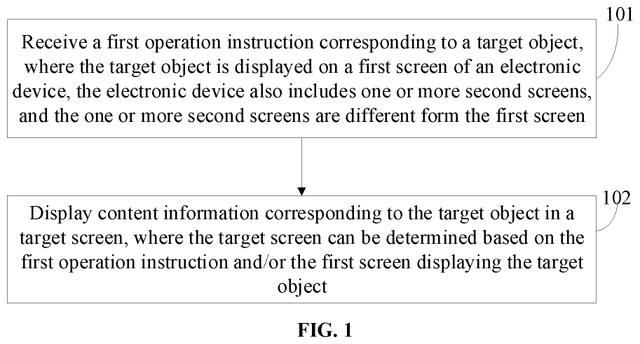

FIG. 1 is a schematic flowchart of an information processing method according to some embodiments of the present disclosure. As shown in FIG. 1, the method includes receiving a first operation instruction corresponding to a target object (at 101). The target object is displayed on a first screen of an electronic device. The electronic device includes at least one second screen which is different from the first screen.

In some embodiments, the target object may include an application icon. The user can perform a double-click operation on the application icon through an input device, and the first operation instruction received by the electronic device for the application icon may be an instruction to start an application (e.g., an instruction to start the application corresponding to the application icon). The user can perform a right-click operation on the application icon through the input device, and the first operation instruction received by the electronic device for the application icon may be a menu-invoking instruction (e.g., an instruction to open a menu of the application corresponding to the application icon).

In some embodiments, the target object may include one of or a combination of a menu bar, a toolbar, an editing column, and a function bar. When the user performs a single-click operation on the target object through the input device, the first operation instruction received by the electronic device for the target object may be an object-invoking instruction (e.g., an instruction to invoke the target object). When the user performs a moving operation on the target object through the input device, the first operation instruction received by the electronic device for the target object may be an object-moving instruction (e.g., an instruction to move the target object). When the user performs an input operation on the target object through the input device, the first operation instruction received by the electronic device for the target object may be an input instruction (e.g., an instruction to input).

The input device one of or a combination of a mouse, a keyboard, a camera, a scanner, a light pen, a handwriting input pad, a joystick, and a voice input device, etc.

In some embodiments, the electronic device may include at least two screens, which may include a first screen and a second screen. In the electronic device, the screen that displays the target object is the first screen, and the screen that does not display the target object can be the second screen. The first screen and the second screen may both be physical screens, or both be virtual screens, or at least one of the first screen or the at least one second screen may be a virtual screen. The virtual screen may be a screen for displaying a virtual image formed by lights projected by an optical module. The optical module may include a light-emitting source to emit light, and a set of optical function members to process the light emitted from the light-emitting source. The light-emitting source may include one or more light-emitting diodes (LEDs) or other light-emitting devices. The set of optical function members may include one or lens for light processing, e.g., focusing, filtering, diverging, etc., the light emitter from the light-emitting source.

The method may further include displaying content information corresponding to the target object in a target screen (at 102), where the target screen can be determined based on the first operation instruction and/or the first screen displaying the target object.

In some embodiments, displaying the content information corresponding to the target object in the target screen may include in response to the first operation instruction received by the electronic device, obtaining screen attribute information of the target screen based on the first operation instruction. In response to determining the target screen being the virtual screen according to the screen attribute information, the content information corresponding to the target object displayed by the target screen can be determined as the virtual information. In response to determining the target screen being the physical screen according to the screen attribute information, the content information corresponding to the target object displayed by the target screen can be determined to be the entity information.

In some embodiments, when the content information corresponding to the target object displayed on the target screen is the virtual information, the content information displayed on the target screen is projected to a receiver object by an optical module in a manner of emitting light. In some embodiments, the receiver object may be an AR device.

In some embodiments, determining the target screen based on the first operation instruction and/or the first screen displaying the target object may include in response to the first operation instruction received by the electronic device, determining one of the first screen and the at least one second screen as the target screen according to the first operation instruction.

In some embodiments, in response to the first operation instruction received by the electronic device being the object-invoking instruction, the first screen where the target object is located can be determined as the target screen based on the object-invoking instruction.

In some embodiments, in response to the first operation instruction received by the electronic device being a menu-invoking instruction, a menu window corresponding to the target object can be displayed in the first screen based on the menu-invoking instruction. When the electronic device receives a screen-selecting instruction for the menu window input by the user through the input device, based on the screen-selecting instruction, the electronic device determines the first screen or the second screen as the target screen.

The first operation instruction received by the electronic device may be an instruction indicating information protection. In response to first instruction received by the electronic device being the instruction indicating information protection, based on the instruction indicating information protection, an information protection window of the target object can be displayed on the first screen or the second screen, and the screen where the information protection window is located can be determined as the target screen.

The instruction indicating information protection may be an encryption instruction, the information protection window may be an encryption window, and the screen where the information protection window is located may be a virtual screen.

In some embodiments, determining the target screen based on the first operation instruction and/or the first screen displaying the target object may further include: in response to receiving the first operation instruction, the electronic device determines the first screen as the target screen based on the first screen displaying the target object.

In some embodiments, determining the target screen based on the first operation instruction and/or the first screen displaying the target object may further include: when the at least one of the first screen and the at least one second screens is a virtual screen, in response to the first operation instruction received by the electronic device being the object-invoking instruction, the electronic device can determine one of the at least one virtual screen as the target screen.

In some embodiments, after determining the target screen, the electronic device may start the application corresponding to the application icon, open a target menu option in the menu bar, open a target tool option in the tool bar, perform edit on a target in the edit bar, or open a target function in the function bar in the target screen, based on the object-invoking instruction.

With the information processing method provided by the present application, if the electronic device has multiple screens, content information window corresponding to a file or an application can be directly displayed or started on the screen where an icon of the file or the application is located according to icon-invoking instruction sent by the user for the file or the application. According to a menu-invoking instruction sent by the user for the file or the application, the content information window corresponding to the file or the application can be displayed on a designated screen. As such, operations on target files or applications can be easier and more efficient.

In some embodiments, the electronic device may have a plurality of screens, which include a virtual screen. The content window corresponding to the target file or the target application can be displayed on the designated screen. As such, for those windows with high privacy protection needs, the content window when opened can be displayed on the virtual display screen. The content window can only be visible to the users wearing an AR head display for the whole displaying process of the content window, which effectively improves the privacy protection.

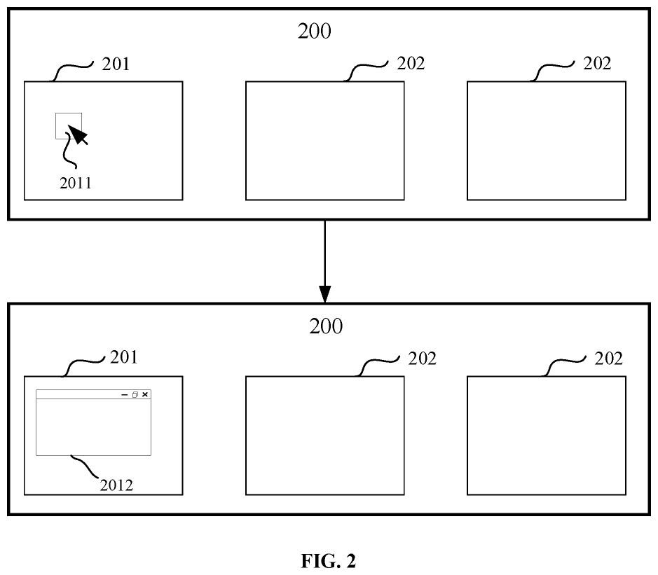

FIG. 2 is a schematic diagram of an exemplary implementation of an information processing method according to some embodiments of the present disclosure. As shown in FIG. 2, the electronic device 200 includes a first screen 201 and two second screens 202. A target object 2011 is displayed on the first screen 201. The user can perform a double-click operation on the target object 2011 on the first screen 201 through an input device to trigger the generation of an object-invoking instruction. The electronic device 200 can receive the object-invoking instruction. In response to receiving the object-invoking instruction, the electronic device 200 opens an information content window 2012 corresponding to the target object 2011 on the first screen 201. In this way, it is not necessary to perform screen setting through a home screen to select the screen for displaying the information content window corresponding to the target object, thereby effectively improving the operation convenience for the target object.

When the first screen 201 is a virtual screen, by directly opening the information content window 2012 corresponding to the target object 2011 on the first screen 201 where the target object 2011 is located, the privacy protection of the target object can be effectively improved.

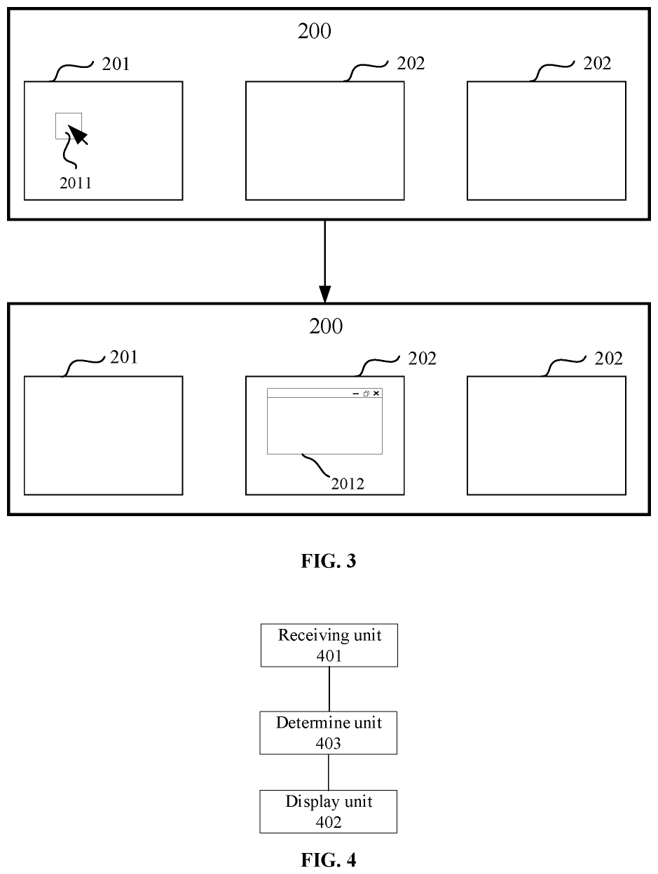

FIG. 3 is a second schematic diagram of another exemplary implementation of an information processing method according to some embodiments of the present disclosure. As shown in FIG. 3, the electronic device 200 includes a first screen 201 and two second screens 202. A target object 2011 is displayed on the first screen 201. The user can perform a right-click operation on the target object 2011 on the first screen 201 through an input device to trigger the generation of a menu-invoking instruction. The electronic device can receive the menu-invoking instruction. In response to receiving the menu-invoking instruction, the electronic device can open a menu window corresponding to the target object 2011 on the first screen 201. The user can trigger a generation of a screen-selecting instruction for the menu window through the input device. In response to receiving the screen-selecting instruction, the electronic device 200 can determine one of the second screens 202 as the target screen according to the screen-selecting instruction, and open the information content window 2012 corresponding to the target object 2011 on the target screen. In this way, it is not necessary to perform the screen setting through the home screen to select a screen for displaying the information content window corresponding to the target object, thereby effectively improving the operation convenience for the target object.

When the second screen 202 is a virtual screen, by opening the information content window 2012 corresponding to the target object 2011 on the designated screen, the privacy protection of the target object can be effectively improved.

FIG. 4 is a schematic structural diagram of an electronic device according to some embodiments of the present disclosure. As shown in FIG. 4, the electronic device includes a receiving unit 401 and a display unit 402.

The receiving unit 401 can receive first operation instruction for a target object. The target object is displayed on a first screen of the electronic device. The electronic device further includes at least one second screen. The second screen is different from the first screen.

The display unit 402 can display content information corresponding to the target object in a target screen. The target screen can be determined based on the first operation instruction and/or a first screen displaying the target object.

In some embodiments, the electronic device may further include a determining unit 403.

In some embodiments, the determining unit 403 can determine, according to the object-invoking instruction, a first screen where the target object is located as the target screen when the first operation instruction is an object-invoking instruction.

In some other embodiments, the determining unit 403 can determine, according to the first operation instruction, one of the first screen and the at least one second screen as the target screen.

In some embodiments, at least one of the first screen and the at least one second screen is a virtual screen. The virtual screen may be a screen for displaying a virtual image formed by lights projected by an optical module.

The determining unit 403 can also determine one of the at least one virtual screen as the target screen in response to the first operation instruction being object-invoking instruction.

In response to receiving the first operation instruction for the target object, the electronic device can display the content information corresponding to the target object in the target screen according to the first operation instruction. The division of units in the above embodiments is only an example. In actual applications, the above processing allocation may be completed by different program modules or program units as needed. For example, the internal structure of the electronic device can be divided into different program modules or units to complete all or part of the processing described above. For details of the electronic device, references can be made to detail descriptions of the above method embodiments.

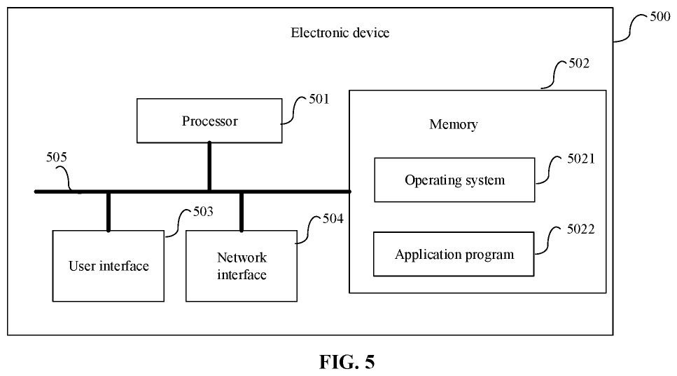

FIG. 5 is a schematic structural diagram of an electronic device according to some other embodiments of the present disclosure. As shown in FIG. 5, the electronic device 500 may be a mobile phone, a computer, a digital broadcast terminal, an information transceiver device, a game console, a tablet device, or a personal digital assistant, an information push server, a content server, an identity authentication server, etc. The electronic device 500 shown in FIG. 5 includes at least one processor 501, a memory 502, at least one network interface 504, and a user interface 503. Various components in electronic device 500 are coupled together by a bus system 505. The bus system 505 is used to implement connection communication between these components. The bus system 505 may include a data bus, a power bus, a control bus, and a status signal bus. For the clarity of description, various buses are labeled as the bus system 505 in FIG. 5.

The user interface 503 may include a display, a keyboard, a mouse, a trackball, a click wheel, a button, a knob, a touch panel, or a touch screen, etc.

The memory 502 can be a volatile memory or a non-volatile memory, and can include the volatile memory and the nonvolatile memory. The non-volatile memory may be a read-only memory (ROM), a programmable read-only memory (PROM), or an erasable programmable read-only memory(EPROM), an electrically erasable programmable read-only memory (EEPROM), a ferromagnetic random-access memory (FRAM), a flash memory, a magnetic surface memory, a compact disc (CD), or a compact disc read-only memory (CD-ROM). The magnetic surface memory can be a disk storage or a tape storage. The volatile memory can be a random-access memory (RAM) that acts as an external cache. Various types of RAM can be used as the volatile memory. For example, the RAM may include such as a static random-access memory (SRAM), a synchronous static random-access memory (SSRAM), a dynamic random-access (SSRAM), a dynamic random-access memory (DRAM), a synchronous dynamic random-access memory (SDRAM), a double data rate synchronous dynamic random-access memory (DDRSDRAM), an enhancement synchronous dynamic random-access memory (ESDRAM), a sync link dynamic random-access memory (SLDRAM), a direct RAM bus random-access memory (DRRAM). The above are only examples of the memory 502. There may be other suitable types of memories.

The memory 502 can store various types of data to support the operation of the electronic device 500. The data may include computer program, e.g., operating system 5021 and application program 5022, for operating on electronic device 500. The operating system 5021 may include various system programs, such as a framework layer, a core library layer, a driver layer, etc., for implementing a variety of basic services and hardware-based tasks. The application program 5022 can include various applications, such as a media player, a browser, etc., for implementing various application services. A computer program for implementing the method embodiments of the present disclosure may be included in the application program 5022.

The method described the foregoing embodiments of the present disclosure may be applied to the processor 501 or implemented by the processor 501. The processor 501 may be an integrated circuit chip with signal processing capabilities. In an implementation process, each step of the foregoing method may be completed by an integrated logic circuit of hardware or an instruction in a form of software in the processor 501. The processor 501 may be a general-purpose processor, a digital signal processor (DSP), or other programmable logic device, a discrete gate or transistor logic device, a discrete hardware component, etc. The processor 501 can implement or perform the various methods, steps, and logic blocks disclosed in the embodiments of the present disclosure. The general-purpose processor can be a microprocessor or any conventional processor, etc. The steps of the method disclosed in the embodiments of the present disclosure may be directly implemented by a hardware decoding processor, or may be performed by software modules or units, or performed by a combination of hardware and software modules/units in the decoding processor. The software module can be included in a storage medium. The storage medium may be in memory 502. The processor 501 can read information from and store information into the memory 502, to in conjunction with the hardware, perform the functions of the software modules/units.

In an exemplary embodiment, the electronic device 500 may be configured by one or more application specific integrated circuits (ASICs), DSPs, programmable logic devices (PLDs), complex programmable logic devices (CPLDs), field-programmable gate arrays (FPGAs), general purpose processors, controllers, micro controller units (MCUs), microprocessors, or other electronics components, which can implement the aforementioned method.

In some embodiments, when the computer programs are executed by the processor 501, the processor 501 can receive first operation instruction for a target object, where the target object is displayed on a first screen of the electronic device. The electronic device includes at least one a second screen, and the second screen is different from the first screen.

When the computer programs are executed by the processor 501, the processor 501 can display content information corresponding to the target object in a target screen, where the target screen can be determined based on the first operation instruction and/or a first screen displaying the target object.

When the computer programs are executed by the processor 501, the processor 501 can in response to the first operation instruction being an object-invoking instruction, determine the first screen where the target object is located as the target screen according to the object-invoking instruction.

When the computer programs are executed by the processor 501, the processor 501 can determine one of the first screen and the at least one second screen as the target screen according to the first operation instruction.

In some embodiments, at least one of the first screen and the at least one second screen is a virtual screen. The virtual screen may be a screen for displaying a virtual image formed by lights projected by an optical module. The optical module may include a light-emitting source to emit light, and a set of optical function members to process the light emitted from the light-emitting source. The light-emitting source may include one or more light-emitting diodes (LEDs) or other light-emitting devices. The set of optical function members may include one or lens for light processing, e.g., focusing, filtering, diverging, etc., the light emitter from the light-emitting source.

When the computer programs are executed by the processor 501, the processor 501 can in response to the first operation instruction being an object-invoking instruction, determine one of the least one virtual screen as the target screen.

The first operation instruction further includes an instruction indicating information protection.

In some embodiments, the present disclosure further provides an electronic device that can be used as a computer readable storage medium. For example, the electronic device includes a memory 502 storing computer programs. When the computer programs are executed by a processor 501 of the electronic device 500, the processor 501 can complete the above described methods. The computer readable storage medium may be a memory such as FRAM, ROM, PROM, EPROM, EEPROM, Flash Memory, magnetic surface memory, optical disk, or CD-ROM. The computer readable storage medium may be a device including one or a combination of the above memories. For example, the computer readable storage medium may be a mobile phone, a computer, a tablet device, a personal digital assistant, etc.

Another aspect of the present disclosure provides an electronic device. The electronic device includes a processor and a computer-readable storage medium. The computer-readable storage medium stores one or more computer-executable programs. When the computer-executable programs are executed by the processor of the electronic device, the electronic device can receive a first operation instruction for a target object. The target object can be displayed on the first screen of the electronic device. The electronic device may further include at least one second screen. The second screen is different from the first screen.

When the computer-executable programs are executed by the processor of the electronic device, the electronic device can display content information corresponding to the target object in a target screen. The target screen is determined based on the first operation instruction and/or the first screen displaying the target object.

When the computer-readable program is executed by the processor, the electronic device can in response to the first operation instruction received by the electronic device being an object-invoking instruction, determine a first screen where the target object is located as the target screen based on the object-invoking instruction.

When the computer-readable program is executed by the processor, the electronic device can determine one of the first screen and the at least one second screen as the target screen based on the first operation instruction.

In another example, at least one of the first screen and the at least one the second screens may be a virtual screen. The virtual screen may be a screen for displaying a virtual image formed by lights projected by an optical module.

When the computer program is executed by the processor, the process can determine one of the at least one visual screens as the target screen in response to the first operation instruction being the object-invoking instruction.

The first operation instruction further includes an instruction indicating information protection.

The above are only some embodiments of the present disclosure. The scope of the present disclosure is not limited thereto. Any person skilled in the art can make changes or substitutions within the technical scope of the present disclosure. These changes and substitutions should fall within the scope of the present disclosure. Therefore, the scope of protection of the present disclosure should be determined by the scope of the claims.

What is claimed is:

1. An information processing method, the method comprising:
receiving a first operation instruction for a target object, wherein the target object is displayed on a first screen of an electronic device, the electronic device comprising the first screen and one or more second screens;
determining a target screen based on the first operation instruction and the first screen displaying the target object; and
displaying content information corresponding to the target object in the target screen.

2. The method of claim 1, wherein determining the target screen based on at least one of the first operation instruction and the first screen displaying the target object comprises:
determining, in response to the first operation instruction comprising an object-invoking instruction for invoking the target object, the first screen in which the target object is located as the target screen based on the object-invoking instruction.

3. The method of claim 1, wherein determining the target screen based on the first operation instruction and the first screen displaying the target object comprises:
determining, based on the first operation instruction, one of the first screen and the one or more second screens as the target screen.

4. The method of claim 1, wherein at least one of the first screen and the one or more second screens comprises a virtual screen configured to display a virtual image formed by lights projected by an optical module.

5. The method of claim 4, wherein determining the target screen based on the first operation instruction and the first screen displaying the target object comprises:
determining, in response to the first operation instruction comprising an object-invoking instruction for invoking the target object, one of the at least one virtual screen as the target screen.

6. The method of claim 5, wherein the first operation instruction further comprises an instruction indicating information protection.

7. The method of claim 6, wherein displaying the content information corresponding to the target object in the target screen comprises:
displaying, in response to the first operation instruction being the instruction indicating information protection, an information protection window of the target object.

8. An electronic device, comprising:
a first screen configured to display a target object;
one or more second screens; and
a processor configured to:
receive a first operation instruction for the target object;
determine a target screen based on the first operation instruction and the first screen displaying the target object; and
display content information corresponding to the target object in a target screen.

9. The electronic device of claim 8, wherein the processor is further configured to:
determine, in response to the first operation instruction being an object-invoking instruction for invoking the target object and according to the object-invoking instruction, the first screen where the target object is located as the target screen.

10. The electronic device of claim 8, wherein the processor is further configured to:
determine, based on the first operation instruction, one of the first screen and the one or more second screens as the target screen.

11. The electronic device according to claim 8, wherein:
at least one of the first screen and the one or more second screens comprises a virtual screen configured to display a virtual image formed by lights projected by an optical module.

12. The electronic device of claim 11, wherein the processor is further configured to:
determine, in response to the first operation instruction being an object-invoking instruction for invoking the target object, one of the least one virtual screen as the target screen.

13. The electronic device of claim 12, wherein the first operation instruction further comprises an instruction indicating information protection.

14. The method of claim 13, wherein the processor is further configured to:
display, in response to the first operation instruction being the instruction indicating information protection, an information protection window of the target object.

15. An electronic device comprising:
a processor; and
a memory configured to store computer programs, wherein when the computer programs are executed by the processor, the processor is configured to:
receive a first operation instruction for a target object, wherein the target object is displayed on a first screen of an electronic device, and the electronic device comprises the first screen and one or more second screens;
determine a target screen based on the first operation instruction and the first screen displaying the target object; and
display content information corresponding to the target object in the target screen.

16. The electronic device of claim 15, wherein the processor is further configured to:
determine in response to the first operation instruction comprising an object-invoking instruction to invoke the target object, the first screen in which the target object is located as the target screen based on the object-invoking instruction.

17. The electronic device of claim 15, wherein the processor is further configured to:
determine, one of the first screen and the one or more second screens as the target screen based on the first operation instruction.

18. The electronic device of claim 15, wherein at least one of the first screen and the one or more second screens is a virtual screen, and the at least one virtual screen is configured to display a virtual image formed by lights projected by an optical module.

19. The electronic device of claim 16, wherein the processor is further configured to:
determine, in response to the first operation instruction comprising an object-invoking instruction for invoking the target object, one of the at least one virtual screen as the target screen.

20. The electronic device of claim 17, wherein the first operation instruction further comprises an instruction indicating information protection.
